(19) United States
(12) Patent Application Publication
(10) Pub. No.: US 2006/0127432 A1
(43) Pub. Date: Jun. 15, 2006

(54) Surface treatment for wood and wood products

(76) Inventor: Francisco Javier Romero Amaya, Peachtree City, GA (US)

Correspondence Address: HODGSON RUSS LLP, ONE M & T PLAZA, SUITE 2000, BUFFALO, NY, 14203-2391, US

(21) Appl. No.: 10/537,192

(22) PCT Filed: Dec. 5, 2003
(86) PCT No.: PCT/AU03/01621

§ 371 Date: Oct. 12, 2005

(30) Foreign Application Priority Data
Dec. 5, 2002 (AU) 2002953128

(51) Int. Cl. A01N 25/00

(52) U.S. Cl. 424/405

(57) ABSTRACT

The invention provides methods and apparatus for the surface treatment of wood using synthetic pyrethroids such as bifenthrin as well as wood products made using those surface treatments.

### FIELD OF THE INVENTION

The invention pertains to wood treatment and more particularly to surface treatments of wood using synthetic pyrethroids.

### BACKGROUND OF THE INVENTION

Bifenthrin is a synthetic pyrethroid insecticide/acaracide that is classified as a non-cyano pyrethroid. The active ingredient is efficacious to target pests through both contact and stomach action. As with most synthetic pyrethroids bifenthrin is active against a wide range of pests including Coleoptera, Diptera, Heteroptera, Hymenoptera, Homoptera, Isoptera, Lepidoptera, Orthoptera as well a number of species of Acarina. Bifenthrin is currently registered in a number of countries throughout the world for the control of a wide range of pests.

Bifenthrin is used extensively in many industries. For example: Cotton, grain, turf, pest control, flower, home garden and mosquito control. However has not been used in the timber industry.

Tests have demonstrated that when using standard practice in the timber industry, very low rates of bifenthrin are required to protect timber against Coptotermes acinaciformis, the most economically important termite species in Australia and Mastotermes darwiniensis, the most voracious in Australia and around the world. The rates are 5 and 20 g/m3 respectively.

Standard treatment methods in Australia and around the world currently require some penetration into the timber by the preservative. This can be achieved by vacuum pressure, vacuum-vacuum systems that require a treatment vessel and expensive peripheral and computerized equipment. The process time required to treat the timber varies depending on the product but takes at least 45 minutes to treat wood. Penetration of preservatives can also be achieved by diffusion, a process which involves less expensive equipment but requires much more time and higher levels of stock holding. Wood moisture content is one of the most important parameters in controlling diffusion times. Wet wood is required to achieve diffusion within commercial expectancy. Full penetration of 90 mm thick radiata pine green sapwood can be achieved between 4 to 8 weeks.

### OBJECTS AND SUMMARY OF THE INVENTION

Accordingly is it an object of the present invention to provide methods and apparatus for the surface treatment of wood using synthetic pyrethroids such as bifenthrin as well as wood products made using those surface treatments.

### BEST MODE AND OTHER EMBODIMENTS OF THE INVENTION

Until this invention, adequately protecting timber against termite attack required a treatment which provided significant penetration of the sapwood. This was the case due to the fact that other available active ingredients degraded very quickly when exposed to increased temperature and Ultra Violet (UV) light. The penetration was required to protect the active ingredient (“active”) from the degradation. The most common used active in the 1990's which penetrated the timber was Permethrin. Permethrin has been shown to degrade when exposed to temperatures above 25 degrees centigrade and has a very low resistance to UV light. Thus, when using Permethrin, it was required to penetrate into the timber otherwise the product would degrade and not protect the timber. Other actives which have been trialed in similar applications such as Deltamethrin were found to cause occupational health and safety (“OH&S”) problems at both the treating site and construction site and also degrade rapidly when exposed to UV light. In OH&S studies conducted in 1998-1999 using timber treated with Deltamethrin, all workers who handled the treated timber complained of a parasthesia or skin irritation. This problem was so severe that it made the use of Deltamethin unviable.

Due to the chemical composition of Bifenthrin, it has been confirmed through extensive OH&S testing that exposure to Bifenthrin treated timber does not produce any skin irritation. Extensive testing done with Bifenthrin showed that significant penetration was not required to protect the active against degradation through exposure to either UV or heat. This increased stability together with the repellent effects of Bifenthrin combined to allow only a superficial treating of the timber where the need for significant penetration is not required.

Other attributes of Bifenthrin which allow it to be used in such superficial applications are its ability to form strong bonds to the timber and the fact that Bifenthrin is virtually insoluble in water. The bonding co-efficient of Bifenthrin is significantly greater than that of Permethrin. These two attributes of bonding & water insolubility, together with the abovementioned stability when exposed to temperature and UV result in the chemical staying on the timber when exposed to rain, sunlight, temperature or handling. No other chemicals used in the past have such characteristics which would allow a mere superficial treatment.

Recent studies have demonstrated that applying bifenthrin superficially by very short dipping (4 seconds) or spraying at very low rates to radiata pine sapwood of commercial sizes protects the timber against termite attack. The rates required to achieve protection are 4 and 23 g/m3 applied on the surface of 35×90 mm radiata pine for Coptotermes acinaciformis and Mastotermes darwiniensis respectively. These studies were conducted using the drum test described by the AWPA protocols. Table 1 shows the evaluation scale used during the inspection of specimens tested. Table 2 and 3 shows the results of the inspection of specimens exposed to Mastotermes and Coptotermes respectively.

TABLE 1
Evaluation scale for radiata pine samples
exposed to termites in the field

| Rating | Condition of the specimen |
|---|---|
| 1 | Sound |
| 2 | Superficial attack-grazing |
| 3 | Penetration - >3 mm in depth |
| 4 | Attack Slight −10-25% mass loss |
| 5 | Attack Moderate 25-50% mass loss |
| 6 | Attack Severe 50-70% mass loss |
| 7 | Attack Destroyed 75-100% mass loss |

TABLE 2
Mean scores for radiata pine commercial samples treated superficially
with bifenthrin and exposed to Mastotermes darwiniensis in the field

| Treat | | | | |
|---|---|---|---|---|
| No | Treatment | Mean | Range | Pass or Fail |
| 1 | Untreated control | 6.7 | 6-7 | Fail |
| 3 | .007% m/m permethrin (LOSP) | 2.2 | 2-3 | Fail |
| 4 | .013% m/m permethrin (LOSP) | 2.2 | 1-4 | Fail |
| 5 | 0.02% m/m permethrin (LOSP) | 1.8 | 1-2 | Pass |
| 10 | Bifenthrin 4 g/m³ | 3.3 | 2-6 | Fail |
| 11 | Bifenthrin 8 g/m³ | 2.2 | 2-3 | Fail |
| 12 | Bifenthrin 15 g/m³ | 2.0 | 1-3 | Fail |
| 13 | Bifenthrin 23 g/m³ | 1.7 | 1-2 | Pass |
| 17 | Bifenthrin 38 g/m³ | 1.0 | 1-1 | Pass |

TABLE 3
Mean scores for radiata pine commercial samples treated superficially
with bifenthrin and exposed to Coptotermes acinaciformis in the field

| Treat No | Treatment | Mean | Range | Pass or Fail |
|---|---|---|---|---|
| 1 | Untreated control | 7.0 | 7-7 | Fail |
| 2 | Solvent control (white spirit) | 7^{b} | 7-7 | Fail |
| 3 | 0.007% m/m OD permethrin | 2 | 1-3 | Fail |
| 4 | 0.013% m/m OD permethrin | 1.8 | 1-3 | Fail |
| 5 | 0.02% m/m OD permethrin | 1.3 | 1-2 | Pass |
| 8 | Determite 4 g/m³ | 1.0 | 1-1 | Pass |
| 9 | Determite 8 g/m³ | 1.0 | 1-1 | Pass |
| 10 | Determite 15 g/m³ | 1.5 | 1-1.5 | Pass |
| 11 | Determite 23 g/m³ | 1.0 | 1-1 | Pass |

House frame building practices were incorporated in a test to demonstrate the efficacy of bifenthrin superficial-treatments. The ends of the samples were not treated. Simulated frames were exposed to 120,000 termites. After six months of exposure all untreated simulated frames were attacked while the treated frames were not despite signs of termite activity within the frame.

Superficial treatments can be applied for example by dipping, rolling, brushing, deluging, misting and spraying. These systems can be installed in different areas of a sawmill in-line or as a process separate to the sawmill. The situation of the spray unit will depend on the lay-out of the production line or lines of a given sawmill. A longitudinal and transversal spray unit in a sawmill is contemplated. Spraying can occur for example by application with a linear sprayer after stress grading. Timber is then arranged on a conveyor, graded and marked by hand (or automatically). Boards that are marked during grading are detected by a scanner and then cut to the appropriate length by the docker saw. Transverse spraying is an option that may occur after the docker saw operation. Ending rolls may be used to treat the ends of the boards as required.

Bifenthrin can be used as a formulated product which includes suspension concentrate, emulsion concentrate, microemulsion and as a dust. Bifenthrin can be applied in a concentrate form or diluted in a variety of carriers which may include water, organic solvent, oils from different sources, diesel, gasoline, petroleum and other non polar solvents.

Additives can be incorporated during the application of bifenthrin, for example colors, fire retardants, water repellents and resins. Table 4 demonstrates that the addition of water repellents did not mask the repellent effect of bifenthrin against Coptotermes acinaciformis.

TABLE 4
Mean scores for radiata pine commercial samples treated
superficially with bifenthrin and water repellent and exposed
to Coptotermes acinaciformis in the field

| | Mean^{a} | | Success (Pass |
|---|---|---|---|
| Treatment | rating | Range | or Fail) |
| Untreated control | 7.0 | 7-7 | Fail |
| Solvent control (white spirit) | ^{7.0}^{b} | 7-7 | Fail |
| 0.007% m/m OD permethrin | 2.0 | 1-3 | Fail |
| 0.013% m/m OD permethrin | 1.8 | 1-3 | Fail |
| 0.02% m/m OD permethrin | 1.3 | 1-2 | Pass |
| Bifenthrin 4 g/m³ + | 1.2 | 1-2 | Pass |
| water repellents | | | |
| Bifenthrin 8 g/m³ + | 1.3 | 1-2 | Pass |
| water repellents | | | |
| Bifenthrin 15 g/m³ + | ^{1.2}^{b} | 1-2 | Pass |
| water repellents | | | |
| Bifenthrin 23 g/m³ + | 1.2 | 1-2 | Pass |
| water repellents | | | |

The benefits of the invention include that:
1. Low rates of chemical usage are obtained.
2. The invention does not need expensive equipment to be applied.
3. The invention allows synthetic pyrethrins to be applied in a sawmill as an in-line process or a stand alone process.
4. The invention eliminates the operating costs associated with conventional treatments.
5. Wood treated according to the invention not required re-drying after treatment. Normal process required re-drying when the end use is framing.
6. Additives can be included in the concentrate or working solution to add different characteristics to the final product. These additives can include colors, fire retardants and water repellents.

Experiments have been conducted, to date, with radiata pine but is not exclusive of other pinus species, other softwood, hardwoods and broadleaves timber species, engineering and re-constituted wood products named for example but not exclusive plywood, Laminated Veneer Lumber, Oriented Stranded Boards (OSB), particleboards, Medium Density Boards (MDF), Glue laminated Lumber (GlueLam), flake boards and plastic-wood.

A modification of superficial treatments is the partial introduction of bifenthrin into the wood. The result of this is an envelope around the cross section of the timber board or wood product or just a partial penetration. Tests conducted following similar method described above strongly suggest that these types of treatment are also effective in protecting termites against termite attack. Table 5 shows the results of the assessment carried out in radiata pine commercial sizes partially penetrated with bifenthrin.

TABLE 5
Mean scores for radiata pine commercial samples partially penetrate
with bifenthrin and exposed to Coptotermes acinaciformis in the field

| | Mean^{a} | | Success (Pass |
|---|---|---|---|
| Treatment | rating | Range | or Fail) |
| Untreated control | 7.0 | 7-7 | Fail |
| Solvent control (white spirit) | ^{7.0}^{b} | 7-7 | Fail |
| 0.007% m/m OD permethrin | 2.0 | 1-3 | Fail |
| 0.013% m/m OD permethrin | 1.8 | 1-3 | Fail |
| 0.02% m/m OD permethrin | 1.3 | 1-2 | Pass |
| Partial penetration more than | 1.0 | 1-1 | Pass |
| 3 mm. Bifenthrin 6-12 g/m³ | | | |
| Partial penetration more than | 1.0 | 1-1 | Pass |
| 3 mm. Bifenthrin 13-20 g/m³ | | | |

When added protection of the faces is required, pressed products can be treated by spraying the faces before they have cooled down. The warmth in the product will create a hot-cold effect that will draw the applying solution deep into the face. Face treatments can also be applied onto a cold face. In this case we rely on the lathe checks as a pathway for the penetration of the chemical. Despite the fact that the penetration of chemical when sprayed on cold faces is not as good as when spraying on warm faces, this can be improved and probably matched to the spraying of warm face by increasing the concentration of the chemical, increasing the uptake and wetting more of the faces, adding surfactants and chemicals that help the solution penetrate the faces better.

The surface treatments of faces can be done by dipping, rolling, brushing, deluging, misting and spraying. These systems can be installed in different areas of the LVL, plywood or any other mill that produces engineered and reconstituted products in-line or as a different process. This depends of the lay-out of the production line or lines of a given mill.

What is claimed is:

1. A method of timber product preservation comprising the step of:
applying a superficial treatment of bifenthrin to the timber product.

2. The method of claim 1, wherein:
the treatment is a spray.

3. The method of claim 2, wherein:
the spray occurs at a sawmill.

4. The method of claim 3, wherein:
the spray occurs by application from a linear sprayer after stress grading.

5. The method of claim 4, further comprising the step of:
a second spray of bifenthrin by way of a transverse spray after a docker saw operation.

6. The method of claim 1, wherein:
the bifenthrin is applied as a formulated product in a carrier.

7. The method of claim 1, wherein:
the bifenthrin further comprises an additive selected from any one of the group comprising: a colorant, a fire retardant, a water repellant or a resin.

8. The method of claim 1, wherein:
the application occurs while the product is warmer than room temperature.

9. The method of claim 1, wherein:
the application occurs by any one of the group comprising: dipping, rolling, brushing, deluging, or misting; and the concentration is between about 4 and 23 g of bifenthrin per cubic meter of product.

10. A timber product having insecticide/acaracide properties, comprising:
a timber substrate to which has been applied a superficial treatment of bifenthrin.

11. The product of claim 10, wherein:
the product is a housing timber or material.

12. The product of claim 10, wherein:
the product retains significant insecticide/acaracide properties above 25 degrees centigrade.

13. The product of claim 10, further comprising:
about 4 g of bifenthrin per cubic meter of product.

14. The product of claim 10, further comprising:
an additive which is applied during the application of the bifenthrin.

15. The product of claim 14, wherein:
the additive is selected from any one of the group comprising: a colorant, a water repellant, a fire retardant, or a resin.

16. The method of claim 1, wherein:
the bifenthrin is applied without the use of vacuum pressure to achieve penetration.

17. The product of claim 10, further comprising:
about 23 or more g of bifenthrin per cubic meter of product.
